(19) United States
(12) Patent Application Publication
(10) Pub. No.: US 2023/0093518 A1
(43) Pub. Date: Mar. 23, 2023

(54) PLATFORM FOR COORDINATING OUTREACH COLLABORATION

(71) Applicant: Higher Ground a Resource Center, Tucson, AZ (US)

(72) Inventors: Jansen Azarias, Tucson, AZ (US); Barbara Azarias, Tucson, AZ (US)

(21) Appl. No.: 17/894,073

(22) Filed: Aug. 23, 2022

Related U.S. Application Data
(63) Continuation of application No. 16/585,686, filed on Sep. 27, 2019, now abandoned.
(60) Provisional application No. 62/738,674, filed on Sep. 28, 2018.

(51) Int. Cl. G06F 16/9535; H04L 9/06; H04L 67/306; G06F 21/62; G09B 5/12; G06F 16/182

(52) U.S. Cl. CPC G06F 16/9535; G06F 16/1834; G06F 21/6263; G09B 5/12; H04L 9/0637; H04L 67/306; G06Q 10/0635

(57) ABSTRACT

A system, method, server, and computer readable medium for creating a life map. Input is received establishing accounts for one or more students. The accounts are stored in a server. Information associated with each of the one or more students is received utilizing computing or communications devices in communication with the server. A life map is generated for the one or more students in response to receiving the information.

### CROSS-REFERENCE TO RELATED APPLICATION(S)

This application is a continuation of U.S. Pat. Application No. 16/585,686, filed on Sep. 27, 2019, which claims priority to and the benefit of U.S. Provisional Application No. 62/738,674, filed on Sep. 28, 2018. entitled “PLATFORM FOR COORDINATING OUTREACH COLLABORATION,” the entire content of all of which is incorporated by reference herein.

### BACKGROUND

The ability of organizations to help individuals, such as “at risk” youth is a complex problem. Oftentimes, there is no predictability regarding the life, personality, and educational skills that youth need to address their own unique challenge and problems. In fact, there are numerous factors that may influence their behavior both positively and negatively. In particular, it is important to recognize and address the key factors most likely to affect each individual. Coordinating so much information is complicated, coordinating information between multiple organizations becomes even more complicated than it should be.

### SUMMARY

Illustrative embodiments provide a system, method, server, and computer readable medium for creating a life map. Input is received establishing accounts for one or more students. The accounts are stored in a server. Information associated with each of the one or more students is received utilizing computing or communications devices in communication with the server. A life map is generated for the one or more students in response to receiving the information. The illustrative embodiments also provide a server, controller, or specialized computer including a processor and memory for performing the process herein described and a computer readable medium including a non-transitory memory for tracking outcome specific data.

Another embodiment provides a system for creating a life map of individuals. The system includes computing and communications devices in communication with a server through one or more networks . The system also includes a server configured to receive input establishing accounts for one or more individuals, wherein the accounts are stored in a server, receive information associated with each of the individuals utilizing the computing or communications devices in communication with the server, and generate a life map for the one or more individuals in response to receiving the information. The system also includes a database in communication with the server, the database configured to store the accounts and information associated with each of the one or more individuals.

In some embodiments, the server is accessed through a cloud network. and an application executed by the computing or communications devices is utilized to receive user input from the influencers. Any number of devices may communicate utilizing different applications and programs that may communicate to coordinate the applicable information and data.

In some embodiments, a controller includes a processor for executing a set of instructions and a memory for storing the set of instructions. The set of instructions are executed by the processor to receive input establishing accounts for one or more individuals, wherein the accounts are stored in a server, receive information associated with each of the individuals utilizing the computing or communications devices in communication with the server, and generate a life map for the one or more individuals in response to receiving the information.

### BRIEF DESCRIPTION OF THE DRAWINGS

Illustrative embodiments are described in detail below with reference to the attached drawing figures, which are incorporated by reference herein and wherein:

FIG. 1 is a pictorial representation of a school system in accordance with an illustrative embodiment;

FIG. 2 is a block diagram of a server in accordance with an illustrative embodiment;

FIG. 3 is a pictorial representation of a life map in accordance with an illustrative embodiment:

FIG. 4 is a flowchart of a process for generating a life map in accordance with an illustrative embodiment;

FIG. 5 is a flowchart of a process for utilizing the life map in accordance with an illustrative embodiment; and

FIGS. 6 - 15 are pictorial representations of user interfaces for displaying and receiving information in accordance with illustrative embodiments.

### DETAILED DESCRIPTION OF THE DRAWINGS

The illustrative embodiments provide systems, methods, devices, servers, platforms, instruction sequences, computer program products, models, and networks for optimizing. managing, and tracking risk factors. In one embodiment, a student life map may be utilized to capture all of the factors that may play a role in a child’s development. The embodiments may also be utilized for users of all ages and factors utilized to promote positive learning and developments. The student life map may be utilized audibly, visually, and tactilely as well as being communicated to any number of devices and user. Common examples of information and data tracked in the student life map include risk behaviors, influencers, and goals.

The illustrative embodiments may allow information to be shared between different organizations (e.g., a single student may participate in multiple schools/organizations). The illustrative embodiments may be utilized across schools, organizations, facilities, entities, groups, or locations for users or individuals of any age. As a result, the student may be matched with services, social workers, actions, and solutions through the illustrative embodiments with input from administrators, parents, social workers, teachers, and others.

The illustrative embodiments provide a system and method for helping parents, students, and authorized adults reach their success goals while providing resources for skill development. The various success indicators and potential fail points are tracked. These indicators provide recommendations for a suggested course of action in a variety of student life scenarios. The suggested course of action may be communicated to the student as requests, notifications, or other messages. The course of action may also be printed and mailed to the student, parents, guardians, administrators, or other authorized parties or otherwise communicated or distributed. Various actions may also be implemented utilizing networked devices, such as computers (e.g., with software packages), exercise equipment, science/laboratory/hands-on equipment, smart phones, and other electronic devices.

Reference is made to tracking data and information relevant to students. However, the students may also represent patients, employees, participants, or other individuals of any age. One or more unique identifiers may be utilized to identify each student.

In one embodiment, different types of users may have access to the data and information managed by the system including at least administrators and mentors. The different types of users may have different access levels to the data and information for reviewing, adding/editing, or deleting information. For example, an administrator may have full read, write, edit, and save access while a parent may only be able to review data and information and provide information for family specific fields. The administrators may use the system to add students, influencers, and templates (e.g., types of risks, types of benefits, types of goals, etc.), and communicate student reports. Different users may have different access levels, fields, and interfaces that they are able to interact with to review, add, and update information. The mentors may use the system to view, add, and update information that is specific to an individual student.

The illustrative embodiments may communicate, receive, and display the data and information through any number of networks to multiple devices (e.g., smart phones, tablets, personal computers, servers, etc.). In one embodiment, a server may store the data and information in one or more databases for access by multiple users. One or more mobile applications and/or programs, websites, virtual/augmented reality, and other access points may be utilized to manage the data and information. Various applications may be utilized to compile and manage the information and data described herein. For example, a student application, a parent/guardian application, and an administrator application may be utilized to share and manage information relating to a student along with actions, best practices, alerts, and so forth. The multiple applications may store information in a common system to provide a coordinated effort to best support the students that is a vast improvement over previous processes and systems.

The illustrative embodiments provide a mobile system and platform (e.g., Apple, Android, etc.) for uploading, receiving, and otherwise communicating data and information in any number of different locations. The system may be utilized to teach any number of students, parents, and authorized adults life skills and other applicable information. The various embodiments may be utilized to coach parents, foster parents, guardians, and other authorized parties in parenting their children by identifying root causes of certain behaviors, improving specific socio-emotional skills, or identifying potential negative behaviors driven by a traumatic event or major life change giving specific evidence-based parenting strategies to address, specific areas, local resources that will help address their area of concern, and other resources that may help them in their parenting area of concern or improvement. For example, the illustrative embodiments may provide a parental coaching application that may be accessed. For example, a parent may specify the issues faced, applicable conditions, and receive specific input

Artificial intelligence, customization, and adaptive learning may be used over time to enhance the processes utilized to teach students. Customized dashboards may be utilized for data management, mobiles devices, gamification (e.g., for youth), and alerts. The illustrative embodiments may be utilized to perform an assessment of life skills, provide interactions/communications (e.g.. student, family, community, guardians, instructions), tracking, alerts, and enhanced communications. The system may enhance data driven outcomes for goal setting, goal obtainment, goal mastery and applied behavioral analysis. The mobile application may be particularly useful for establishing a care network/community for each student, providing connectivity to tasks, coordinating care, and enhancing personal development. The website portal may be utilized to provide a dashboard, alerts, security and management settings, and coaching management/suggestions. In the embodiments, suggestions, best practices, successful actions, factors associated with successes, and plans are identified through automatic data-mining and analysis as well as user specified parameters, algorithms, and analytics.

The illustrative embodiments are applicable to more than just at-risk students. The illustrative embodiments may be adapted to any number of users, clients, individuals, groups. fields, systems, or environments for which goals, outcomes, and risks are addressed (including children, adults, seniors, etc.). As used herein the term “or” is not mutually exclusive.

The illustrative embodiments may include a school network and system utilized to record, manage, and track progress data. One or more system administrators may manage the system for students. As referred to herein a provider is an organization, business, group, school, facility, user, or caregiver, working toward specific goals or objectives or reducing at-risk activities and behaviors. The students may specify goals or objectives . In some instances, goals and objectives are referred to simply as goals.

In one embodiment, a behavioral network and system may be utilized to provide software as a service (SaaS). For example, a county or administrative office may utilize server-level applications, local applications, web programs, and mobile applications available to a number of schools. individual users may then enter, retrieve, manage, and view information and data through any number of wired or wireless computing and communications devices. The different software may be updated as new versions are released. As a result, comprehensive systems and software services may be quickly rolled out to the schools. The students may be added, deleted, or managed from a number of remote locations. In one embodiment, the existing schools records including files and databases may be integrated with other applicable records, databases, software, networks, and systems, to ease any transition concerns. In other embodiments, existing paper records may be digitized for utilization with the school network. Information from existing electronic school records and systems may be uploaded for immediate utilization. The illustrative embodiments may be utilized to communicate with external databases including importing and exporting school, medical, financial, or other sensitive records if the correct authorizations are verified.

In one embodiment, the school network may utilize a cloud network to provide access. The cloud network may allow the system provider to license the system and software more efficiently. The system provider may control the system hosts, student profiles, security access, permissions, key access, and other controls.

In one embodiment, the described systems and method may be utilized to assess atrisk behaviors to provide data to evaluate a variety of diagnostic, cultural, treatment, and regulatory priorities. Shared and collaborative information may result in team sharing of information for providing automated processes for real-time monitoring of progress and outcomes. The illustrative embodiments provide a systematic data collection and analysis system and process. The described methodologies may provide any number of automatic real-time alerts, subscriptions, actions, and interventions to teach, encourage, monitor, and instruct children or other individuals. The illustrative embodiments provide enhanced methods of compiling information form multiple parties to assist parents, foster parents, guardians, teachers, and others. The embodiments are better than one-on-one communications, spreadsheets, or improvised solutions.

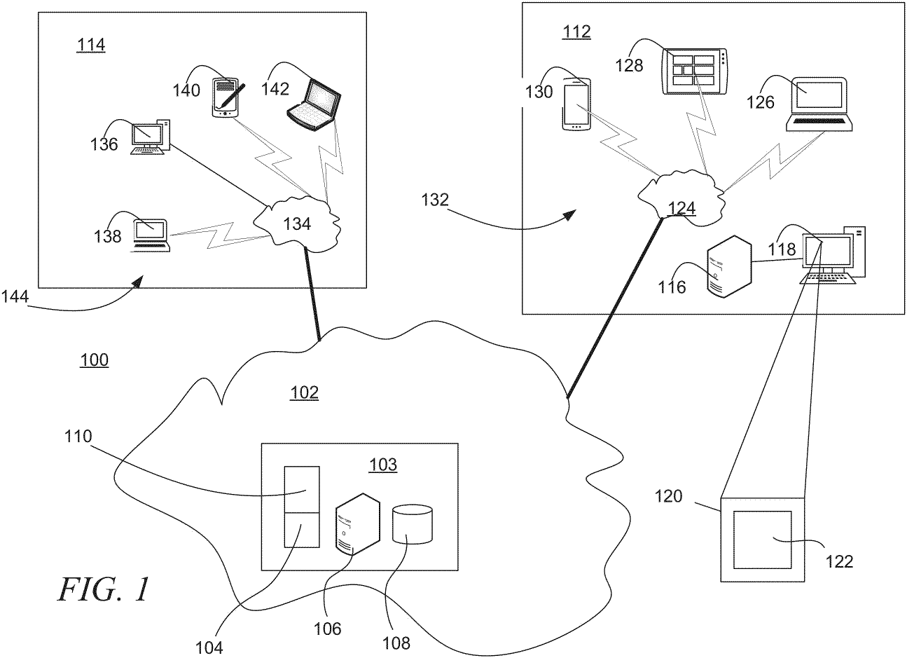

FIG. 1 is a pictorial representation of a school system 100 in accordance with an illustrative embodiment. The school system 100 may include any number of systems, devices, or equipment. For example, the school system 100 may utilize existing school record servers, databases, electronic files, and systems. The school system 100 may also include any number of customized or proprietary systems, software, equipment, devices, or other components that are described herein.

In one embodiment, the school system 100 may include a school network 102 and a management system 103. The school network 102 may include hardware and software components including servers 104, file servers 106, databases 108, and software 110. The school system 100 and the school network 102 are configured to serve numerous schools, customers, organizations, or providers including School A 112 and School B 114. Each of the schools may include any number of networks, servers, computing devices, wireless devices, or network equipment, systems, and so forth. In one embodiment, School A 112 may utilize a server 116, a computer 118 displaying a graphical user interface (GUI) 120 to illustrate a school record 122.

The School A 112 may further utilize a network 124 and wireless devices 126, 128, 130 (hereinafter “wireless devices 132”). School B 114 may utilize a network 134, a computer 136, and wireless devices 138, 140, 142 (hereinafter “wireless devices 144”). The wireless devices 132 and 144 may be utilized for direct communications (e.g., wired or wireless), network communications, or may be utilized offline. The information and data may be entered utilizing a keyboard, speech recognition, imaging system, microphones, or any number of other devices or peripherals known in the art.

In one embodiment, the management system 103 is one or more devices utilized to enable, initiate, route, and manage communications between one or more computing and communications devices and providers, such as School A 112 and School B 114. The management system 103 may include one or more devices networked to manage the school network 102. For example, the management system 103 may include any number of servers (e.g., web, application, database, FTP, game, audio/video, proxy, virtual, etc.), routers, switches, or advanced intelligent network devices. The school network 102 sends and receives the electronic signals through any number of transmission mediums. The school network 102 may include various fiber optics, cables, transmission towers, antennas, or other components for transmitting data, communications, information, and files.

The school network 102 may represent any number of communications networks and utilize connections including wired or wireless networks, data or packet networks, cable networks, satellite networks, private networks, publicly switched telephone networks (PSTN), proprietary, or other types of communication networks. For example, communications within the health environment 102 may occur utilizing satellite connections, Wi-Fi, infrared, Bluetooth, ZigBee, cellular networks, and/ or hardwired connections, such as fiber optics, T1, cable, DSL, standard telephone lines, Ethernet, power line networking, or other digital or analog communications connections. Any number of communications architectures including client-server, network rings, peer-to-peer, tiered networks, application servers, distributed networks, or other network systems may be utilized. Any number of existing or developing standards, protocols, signals, and processes may be utilized.

In one embodiment, communications utilizing the wireless devices 132, 144 may occur directly or through network devices using communications protocols, such as time division multiple access (TDMA), code division multiple access (CDMA), global systems for mobile (GSM) communications, personal communications systems (PCS), Wi-Fi, WLAN, 3G, 4G. 5G, or other frequently used cellular and data communications protocols and standards . The wireless devices 132 and 144 may include cellular phones, smart phones, personal digital assistants (PDA), mp3 players, laptops, the readers, evolution data optimized (EDO) cards, hybrid devices, tablets, multi-mode devices, and other wireless communication devices and components . The illustrative embodiments provide an unconventional way of interacting with multiple parties to manage and coordinate information, data, alerts, interventions, activities, actions, outside parties, and so forth. The illustrative embodiments are more effective than traditional spreadsheets and standard communications (e.g., parents and administrators/teachers emailing, texting, or calling one another over each potential issue and solution). The illustrative embodiments provide an improved technology, method, devices, and systems of managing comprehensive information regarding students, clients, or other parties. For example, the efficiency of tracking and updating information is removed from a small number of parties (reducing the burden) and spread across stake holders (e.g., parents, guardians, administrators, teachers, third parties, etc.) to obtain information more quickly and manage the information and actions implemented based on the information.

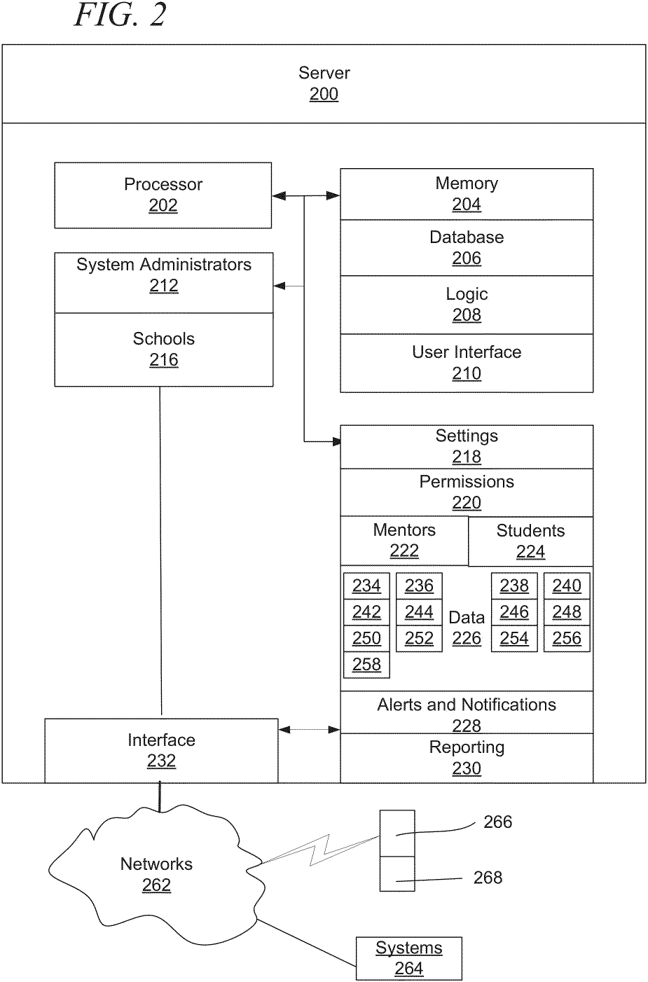

FIG. 2 is a block diagram of a server 200 in accordance with an illustrative embodiment. However, FIG. 2 may represent any of the electronic devices of FIG. 1. In one embodiment, the server 200 may include a processor 202, a memory 204, a database 206. logic 208, a user interface 210, system administrators 212, schools 216, settings 218, permissions 220, mentors 222. students 224, data 226, alerts and notifications, and reporting 230, and an interface 232. The data 226 may include personal information 234, assessment information 236, activity information 238, medical information 240, diagnosis data 242, benefit information 244, risk information 246, personality profile 248, influencer information 250, potential gaps 252. school information 254, student timeline 256, and goals 258. The functions, processes, and steps described may also be implemented as one or more methods, systems, and devices that may be combined across the Figures and description included herein.

The server 200 may communicate with networks 262, systems 264, and electronic devices 266 utilizing applications 268. The networks 262 may represent any number of networks. For example, the electronic devices 266 may represent smart phones, tablets, laptops, personal computers, or other computing or communications devices utilized by the parties associated with the server 200. The systems 264 may represent any number of outside servers, databases, software implementations, and devices whether commercial or personal. The systems 264 may communicate additional information to the server 200 that may be relevant to the system administrators 212, schools 216, mentors 222, students, 224, data 226 (or other components of the server 200). For example, the systems may represent external devices, services, or resources that may be accessed by the server 200.

In one embodiment, the server 200 is a computing device or group of networked or distributed computing devices. The server 200 may have any number of hierarchical users including, system administrators 212, schools 216, IT support, support staff, teachers, guardians, caregivers, and other similar users. In one embodiment, to add any of the described students. entities, groups, or users to the server 200, any of the following information or data may be required: name (e.g., first, last, username, nickname, etc.), age, date of birth, physical address, email address, image, mobile telephone number, school/user identification. Administrators, employees, parents, guardians, caregivers, or teachers may be required to also provide work number, role (e.g., system administrator, service providers, parent, etc.), password, designated supervisor, comments, and other related information.

The server 200 or other applicable electronic device may be specially configured to perform the embodiments herein described. The processor 202 is circuitry or logic enabled to control execution of a set of instructions. The processor 202 may be microprocessors, digital signal processors, application-specific integrated circuits (ASIC), central processing units, or other devices suitable for controlling an electronic device including one or more hardware and software elements, executing software, instructions, programs, sets of instructions, and applications, converting and processing signals and information, and performing other related tasks. The processor 202 may be a single chip or integrated with other computing or communications elements.

The memory 204 is a hardware element, device, or recording media configured to store data for subsequent retrieval or access at a later time. The memory 204 may be static or dynamic memory The memory 204 may include a hard disk, random access memory, cache, removable media drive, mass storage, or configuration suitable as storage for data, instructions, and information. In one embodiment, the memory 204 and processor 202 may be integrated. The memory may use any type of volatile or non-volatile storage techniques and media.

The database 206 may be utilized to store the data 226. The database 206 may include a database management system, such as SQL (and variations). Access, Oracle, and DB2. In one embodiment, the interface 232 may include a transceiver configured to both transmit and receive communications for the server 200. For example, the interface may include one or more transceivers. The networks 242, systems 244, wireless devices 246 and applications 248 may represent all or a portion of the school system 100 of FIG. 1, such as School A 112 or client 114. The database 206 may be configured for data mining of available information and data as is known in the art. The database 206 may include one or more databases. For example, different information and data from different parts of the life map may be included in different databases.

In another embodiment, the server 200 may act as a web server hosting content that may be retrieved and managed. The illustrative embodiments may be implemented utilizing a web browser for entering, updating, and managing information, goals, activities, and other 226 data. In one embodiment, the software, information, and data utilized by the server 200 may be indexed, archived, or otherwise made available for queries and secured web-based searches. As a result, the system administrators 212 and schools 216 may search the data 226 based on the applicable settings 218 and permissions 220 to determine suggestions, models, and best practices.

In one embodiment, information, settings, and data utilized by the server 200 is saved or duplicated by one or more redundant systems for backup, failover, or network purposes utilizing any number of backup standards, formats, or protocols. The various components of the server 200 may represent an application that is stored in the memory 204 and executed by the processor to perform the illustrative embodiments. The server 200 may host an application that communicates with other devices executing a local copy or version of the application (e.g., applications 248). The data 226 may be similarly be synchronized and shared between applications in real-time or near real-time. As a result, multiple schools 216 (or other users) may be able to edit the data 226 simultaneously or concurrently while seeing the changes made by their counterparts. Online shared or collaborative interfaces, software, and components may be utilized.

In one embodiment, the system administrators 212 may control upload of the schools 216, students 224, and other applicable information and data into the systems of the server 200. In one embodiment, the system administrators may be prevented from seeing specific types of data. However, in one example, general information, such as effectiveness of the activities (activity information 238) may be made available to the system administrators 212 for further enhancing the server 200 and providing additional actions and best practices to a number of schools 216 that the system administrator 212 manages.

Schools 216 may be provided unique access to the server 200 through a user interface 210. The user interface 210 may be represented by programs, applications, secure access protocols (e.g., web interfaces, virtual private networks, remote access software, etc.) or systems made available through the server 200. such as the user interface 210, or alternatively, the applications 248, or the systems 244. For example, the user interface 210 may present a dashboard, portal, application, or webpage (e.g., accessed through smart phones, tablets, laptops, personal computers, etc.) for managing the described information and data. The system administrators 214 may have complete read/write access to the user accounts represented by the schools 216 including the settings 218, permissions 220, students 224 and data 226. In one embodiment, the user interface 210 may display any number of icons, images, drop-down menus, videos, hyperlinks, internal links, scroll wheels, tabs, windows, or other selection or display components.

The mentors 222 may track the mentor information (e.g., name, age, specialty, qualifications, education, unique identification, etc.), assigned students, start/end date, description, type of mentor (e.g., teacher, volunteer, etc.), and so forth. The data 226 may also track the history and success rates for mentors with each specific student. The mentor information may also specify types of students or students with particular risks that the mentor has had success addressing in the past. For example, a particular mentor may have high degrees of success in preventing or assisting her students in avoiding drug problems or addiction based on past experiences, training, and so forth.

As noted, the personal information may include a name, age, date of birth, address, phone number, unique/student identification, and other applicable information (e.g., social security number, referral source, etc.). The assessment information 236 may include data associated with one or more tests taken by the student 224 or assessments performed. For example, each assessment test may have a template, identification, title, version, and test type (e.g., emotional intelligence, grit test, etc.), date, score, and so forth.

Each student 224 may participate in multiple activities. This is tracked in the activity information 238. The activity information 238 may specify a unique identification, name of the activity, type of activity (e.g., physical, academic, spiritual, team building, etc.), intensity/level, instructor/mentor, or other applicable information. As noted, each student 224 may participate in multiple activities. The student 224 may also be matched with various organizations or service providers that may be unassociated with the school or facility they are attending. For example, local organizations that may teach the student 224 needed skills or provide applicable experiences may be recommended for the interested parties to evaluate.

The medical information 240 may track applicable health and medical information for each student 224 (e.g., current medical conditions, medical history, doctors/medical professionals, medical history, allergies, medicines/drugs, etc.). The medical information 240 may include information from any number of sources including doctors, nurses, hospitals, schools, organizations, facilities, or locations. For example, the medical information 240 may specify age, height, weight, known conditions, family history, and so forth. The medical information 240 may also indicate the health insurance or government benefits associated with the user. This information may affect how or what treatments the student 224 qualifies for. The data 226 may also specify diagnosis data 242. The diagnosis data 242 may particularly specify diagnosis codes associated with the student 224. The diagnosis data 242 may also include a unique identification, treatment goal, and assessment date.

The data 226 may also include benefit information 244. The benefit information 244 may specify the benefits for which the student 234 qualifies based on health insurance, payment history, scholarships, grants, or so forth. The benefit information 244 may also specify insurance number, group number, verification information, unique identification, start date, expiration date, provider, or so forth.

The risk information 246 may specify risks associated with one or more students 224. The risk information 246 may be determined based on interviews, tests, observation, or other assessments to determine potential or identified risks. Each student may exhibit many risks that are also common across a subset of students in similar situations. The risks may include physical, mental, spiritual, or other risks that are measured, tested, or otherwise determined. For example, common risks may include drug dependency, self-harm, previous risks, medical conditions, sexual risks, and so forth. The risk information 246 may include a risk identification/identifier, description, risks associated with behaviors, and type of risk associated with each student 224 The risk information 246 may also store triggers, historical risks, start, incident, or end dates, repeat likelihood, observations, and so forth. When storing risk data 246 associated with one or more students 224 the data may de-identify the individual, assigned an encrypted identifier, and stored as a risk detail. This provides a process for protecting privacy, maintaining HIPAA compliance, and otherwise protecting the student.

The personality profile 248 may store any relevant information specific to the student 224. such as personality and character trait analysis. The personality profile 248 may specify learning preferences, friends, personal preferences, observation notes, active/inactive, and so forth . The personality profile 248 in particular includes information about the best approaches to develop a relationship with the student and facilitate the student in reaching their goals. The personality profile 248 may be utilized to match programs, activities, actions, and mentors with the student.

The influencer information 250 may specify the influencers in the students 224 lives The information that is stored for each influencer may include a unique identification, phone number, email, physical address, and so forth. In some embodiments, the influencers may address risks associated with the student 224 and there may be zero or numerous influencers. For example, the influencers included in the influencer information 250 may include family members, school mentors (e.g., administrators, employees, volunteers, etc.), friends, partner organizations, outreach centers, non-profits, or so forth. For partner organizations, the server 200 may also store the name of the organization, functions, level of care, assigned impact level, applicable names, primary expertise, secondary expertise, and so forth. For family members and influencers, the server 200 may store names, impact level, highest education level, educational beliefs/attainment, personal values, career, religion, income, and official history. The influencer information 250 may include both primary and secondary influencers. The influencer information 250 may also specify the background, risks, and personality profile of family related influencers. As a result, different family patterns, interactions, and communications styles may be noted and observed (e.g., for efficacy, red flags, etc.). Influencer information 250 may be regularly analyzed utilizing algorithms or machine learning to predict risks for the students 224.

The potential gaps 252 may specify risks that are not being addressed. The potential gaps 252 may include information that is automatically generated from risks that are not being addressed and manual entries from system administrators 212, mentors 222. or influencers based on observations, student comments/interactions, interviews, surveys, tests, or other applicable information. There may be any number of potential gaps 252 for each of the students 224. The potential gaps 252 may include unique identification, type, start/end date, and a description. The potential gaps may also include statistical possibility risks based on trauma and risks for each of the students 224. The illustrative embodiments may assist in predicting potential future behaviors and potential gaps 252 that the students 224 may have because of their combination of personality, risks, traumatic events, influencer or lack thereof location, and other factors.

As previously noted, one influencer may be associated with multiple students and one student may be associated with multiple influencers. For example, a partnered organization that teaches personal finance may be an influencer for many students and that student may have many individuals and partnered organizations helping them. When a student is linked to a specific influencer, that data may be stored in the relationship details of the influencer information 250.

The school information 254 may include information regarding the students 224 schooling. The schooling information 254 may include school and grade identifications, class grades, schools attended, course names, course identification, and so forth. The school information 254 may also include academic analysis. For example, students may take classes or courses from which they receive a grade. The teachers, administrators, and mentors oversee reviewing the grades.

The student timeline 256 may include information and data including goals and major events that affect the student’s goals. Students are assigned zero or multiple goals or objectives. Goals are assigned a unique identification and goal type. When a student is assigned a certain goal, that information is stored in the goal details. In goal details, we store the start/end date, a comment, the status, mentor assistance, and days left for completion. One student may be assigned one specific goal one time with new goals or modified goals created as needed. Goals may be affected by the major events that occur in the students 224 lives, both positive and negative . These different events may be assigned a unique identification, type, and description. The information about a particular combination of goal detail and event may be stored in impact details. In this we store a unique identification, impact date, impact level, and any notes from the user.

In another embodiment, the personality profile 248 may store personality indicators, character traits, strength factors, or other information, such as extroverted, energetic, optimistic, confident, patient, independent learner, goal oriented, strong reading skills, proficient communicator, basic computer skills, schedule oriented, meets deadlines, web and social network savvy, arrogant, awkward/shy, bad tempered, easily frustrated, negative/disagreeable, impatient, controlling, self-centered/conceited, trouble establishing and completing goals, trouble in school, trouble making friends, limited education, and so forth.

The server 200 may enable any number of queries of the database 206 as well as report generation (i.e., reporting 230). In one example, the data and information relevant to the server 200 (including the data 226) may be stored in the database 206. The various types of queries and reports may be stored in the data 226 or accessed through reporting 230. The reporting 230 may include any number of default and custom reports available to the user. The inquiries may be generated based on algorithms, settings, parameters, or other information included in the logic 208 or other portions of the server 200. In one embodiment, the user may query an attendance report of a student for a week, month, year, school year, or custom time period. The measurements may specify minutes, hours, or days spent in school or participating with an organization. The attendance report may be utilized to determine which students need more individual attention to ensure interest in academics and progression towards reaching their goals.

Another query may be utilized to determine each type of influencer related to a student. The server 200 may utilize the logic 208 to predict based on the applicable data/life map each type of influencer associated with a particular student. As a result, influencers may be positively addressed and corrective actions may be taken as needed. As previously mentioned, influencers may include family members, mentors, partner organizations, and so forth.

Another query may be utilized to generate a report of potential gaps that have been unaddressed (e.g. for the longest time period). Evaluating the “short-term” and “long-term” gaps may be a good measure of the performance and efficiency of the resource allocation managed through the server 200. Applicable information may include the gap type, gap description, days the problem was unaddressed, and so forth.

Another query may be utilized to generate a low grade report. The low grade report may be a sum of all grades or students with the worst grades in their respective classes . The low grade report may be utilized to recognize students that need urgent attention academically. Poor academic performance is often an indication of deeper problems that are meant to be addressed by the illustrative embodiments. Applicable information may include student name, grades in each course/class, rank, or other applicable information. The low grade report may also specify low or unacceptable grades for any number of tests, assignments, projects, labs, homework, or so forth.

Another query may be utilized to generate an event goal report. The event goal report may be utilized to display the event types that most impact the goals and respective average impact level for the student. The event goal report may help users to understand which kind of events require better coping techniques and need to be addressed by the influencers associated with the students. Applicable information may include event type, goals impacted, average impact level, and so forth.

Another query may be utilized to generate reports of courses and corresponding schools that get the lowest grade amongst all students. The school grading report may be utilized to understand which schools have the worst academics records. As a result, additional tutoring, mentoring, and resources may be made available. Applicable information may include institution name, course name, rank, grades, and so forth.

Another query may be utilized to generate a report of emotional intelligence. The emotional intelligence report may specify an emotional quotient or information associated with the students. For example, the emotional intelligence report may specify the social-emotional learning (SEL) which is the process through which children and adults acquire and effectively apply the knowledge, attitudes, and skills necessary to understand and manage emotions, set and achieve positive goals, feel and show empath for others, establish and maintain positive relationships, and make responsible decisions. The social-emotional learning quotient may categorize one or more aspects of the students emotional intelligence for enhancing their well being through teaching, activities, experiences, and the other factors noted herein.

Another query may be utilized to generate an IQ risk report. The IQ risk report may specify the number of students 224 who have a particular risk based on IQ test score ranges. In one embodiment, the IQ test score levels may be categorized into ranges, such as 70-90, 91-120, 120-140, and 141-200. IQ test scores may be classified respectively as low, average, high, and very high. The top risk type associated with the student’s IQ may be displayed. Techniques for addressing risks may be formulated based on the student’s IQ levels. Applicable information may include IQ level, risk type, frequency, and so forth. The IQ risk report may also note self-control and particularly low self-control scores.

Another query may be utilized to generate a student profile. The student profile may display information and data relevant as part of the student summary section available through a mentor dashboard or other user interfaces. Applicable information may include student identification, student address, contact phone number, title, score, and so forth.

Another query may be utilized to generate an organization statistics report. The organization statistics report may return the total number of students each partner organization is working with. Patient statistics report may utilize to determine the partner organizations that are most helping the students achieve positive goals. Applicable information partner name, students, score, and so forth. In one embodiment, partnerships and organizations that are most benefiting students 224 may be rewarded with additional student relationships, recommendations, or business to encourage best efforts and success.

Another query may be utilized to generate a GPA report. The GPA report may compute the GPA of all students or groups of students. Applicable information may include student identification, average GPA, and so forth. The GPA report may also retrieve grades from other schools, organizations, or groups where applicable.

The server 200 or logic 208 may also implement any number of procedures and triggers based on the information and data 226. In one embodiment, a procedure may be implemented to populate potential gaps with risks unaddressed by any influencer. The potential gaps (the issues that a student is facing that are unaddressed by any kind of influencer) in a table may be auto populated. The procedure may utilize information, such as student name, risk level (e.g., short-term, long-term), risk type, gap type, and so forth. As a result, the students 224 may be automatically assigned to mentors, enrolled in classes or projects, receive communications (e.g., text, email, in-application, phone calls, etc.), subject to a status review, or otherwise further evaluated. In all of the various processes, the parents, guardians, teachers, and administrators may be notified of changes based on laws, school requirements, or best practices. Alternatively, the reporting and information may be available for access through the server 200 at any time.

The logic 208 may disallow allocation of a mentor to a student unless there is still room in the mentor’s bandwidth. For example, an error may be raised if the mentor exceeds a certain number of hours in a day, week, or month or students being mentored at one time. As a result, the logic 208 ensures that mentors are not overworked or over engaged so that each student can get the mentor’s full attention when assigned.

The logic 208 may also disallow the insertion of a new benefit associated with a specific student if there is an existing instance of the same benefit for that student that has not yet expired. As a result, the logic 208 ensures that a student does not have multiple instances of the same benefit which has not yet expired to keep the data 226 clean.

The alerts and notifications 228 may send one or more alerts, communications, messages, or notification regarding the students 224 (or other data and information included in the server 200). The alerts and notifications 228 may coordinate communications with administrators, outside organizations/schools/partners, mentors, parents/guardians, students 224 and others. The alerts and notifications 228 may utilize the logic 208, settings 218. or permissions 220 to perform the communications.

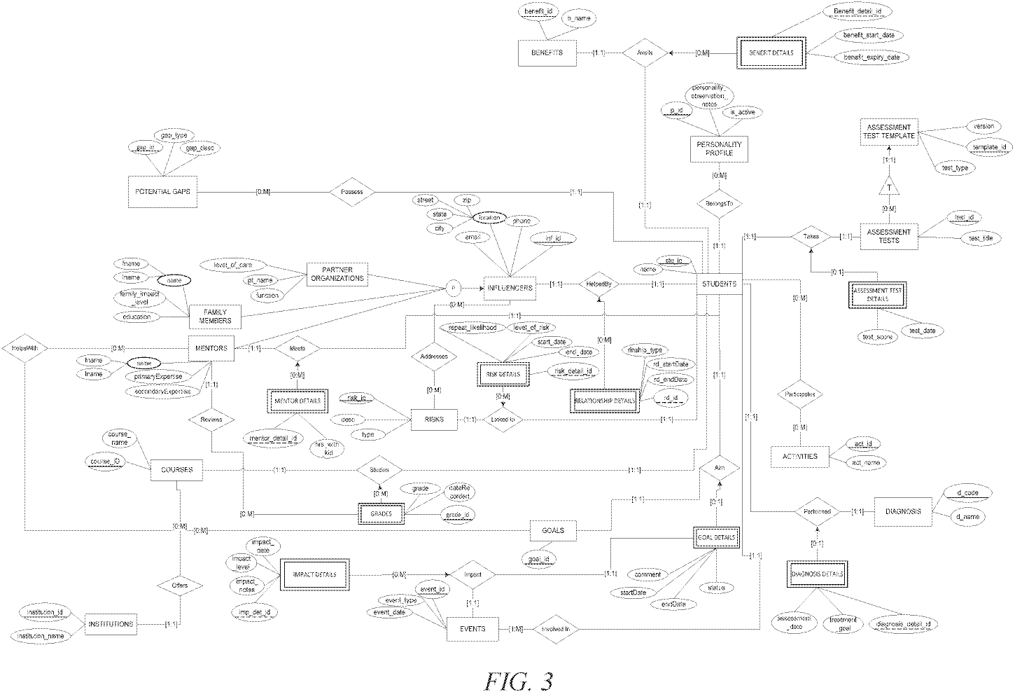

FIG. 3 is a pictorial representation of a life map in accordance with an illustrative embodiment. The life map 300 may include information, data, modules, schemes, logic, and so forth from the server 200, system administrators 212, schools 216, mentors 222. students 224, 226. and other portions of FIG. 2. The life map 300 provides a goal tracking system that evolves and determines potential obstacles for students. The life map 300 also tracks goals and sub goals that may help the student reach their overall goals. The life map 300 utilizes information for a student profile to determine what the students and interested in and then to encourage the development of skills that will help the students obtain those goals. The life map 300 changes as new obstacles and risks arise, situations or environments change (both positive and negative), and as the student learns new skills. The life map 300 tracks various events and stores and assigns a new unique identification associated with the respective data. As noted, the various events may impact the goal completion process.

The life map 300 may be utilized to track and recommend suggestions, courses of actions, interventions, or other scenarios that may positively impact the goal completion process for the student. The life map 300 may also be utilized to receive input from various users of a system or interface. As a result, information applicable to students may be tracked in comprehensive detail. The life map 300 may be utilized to formulate surveys, profile information, mobile applications, and so forth . In addition, logic, algorithms, and sets of instructions may be utilized to request, capture, record, and manage the information and data of the life map 300.

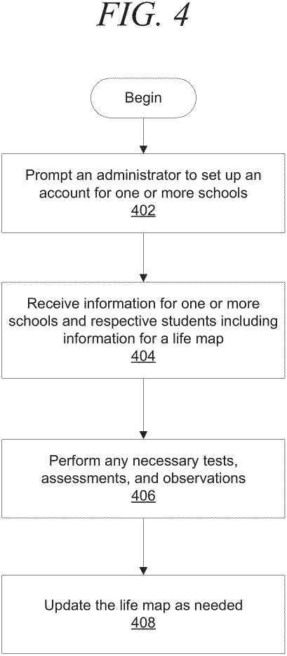

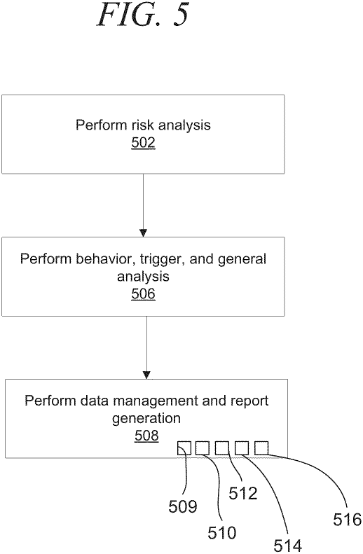

In one embodiment, an application may implement the life map 300 utilizing logic, such as instructions that implement nested questions. The questions may be posed to any number of users that may have information and data relevant to a student. The data may be acquired through one or more devices or interfaces, such as mobile applications, programs, web interfaces, text interfaces, or so forth. The life map 300 may also represent one or more algorithms, applications, or sets of instructions that may be implemented to track the progress and well-being of students, clients, or others. The life map 300 may include information corresponding to the fields, data, and information tracked by the systems and methods herein described (i.e., server 200 of FIG. 2, FIGS. 4-5).

In one embodiment, the constructs of the life map 300 may include activities, assessment test template, assessment tests, assessment test details, benefits, benefit details, courses, diagnosis, diagnosis details, events, goals, goal details, grades, impact details, influencers, family members, mentors, partner organizations, institutions, mentor details, personality profile, potential gaps, relationship details, risks, risk details, students, and so forth.

FIG. 4 is a flowchart of a process for generating a life map in accordance with an illustrative embodiment. In one embodiment, a life map manager or wizard may compile information that is utilized to generate the life map. The process of FIGS. 4 and 5 may be implemented by a server, application, device, or combination of communicating elements referred to as a system. All or portions of the process of FIGS. 4 and 5 may be implemented automatically or in response to input or feedback from a user.

In one embodiment, the process may begin by prompting an administrator to set up an account for one or more schools (step 402). The account may be for a school, organization, or entity with which the student is associated. As previously noted, the student may represent a patient, inmate, participant, or other individual. The account may be established in a system, platform, cloud system, local devices (e.g.. desktop computer, tablets, etc.). The account may include establishing a profile, identifiers, authorized users, passwords, access protocols, and so forth.

Next, the system receives information for one or more schools and respective students including information for a life map (step 404). The life map may include any of the information and data herein disclosed (see for example, the life map 300 of FIG. 3). The information and data associated with the life map may be received based on paperwork, conversations, websites, Internet interfaces, electronic forms, imported content, mobile applications, or so forth. For example, a series of probes or questions may guide a user (e.g., parent, guardian, student, etc.) through completing fields that may generate the life map as described in FIGS. 1-3 and shown in FIG. 2. The life map may be initially generated or updated over time (e.g., hours, days, weeks, months, years, etc.). For example, the life map may be generated based on initially information provided by the student and parents/guardians and then updated throughout a school year.

Next, the system performs any necessary tests, assessments, and observations (step 406). During step 406 the student may be tested utilizing standardized or customized tests (e.g., academic, personality, stress, interaction, etc.). The student may also be observed in any number of environments to determine applicable information. The student may be observed over time to determine relevant information both positive and negative, such as mentor/student relationships, self-worth, mental health, classroom pride, classroom engagement, support system task completion history, academic successes/failures, home environment, engagement level, addictions, gang activity level, fighting/aggression, depression, hyperactivity, social behavior, self-harming behaviors, overall health, past education, family dynamics, criminal record, past trauma, genetics, personal characteristics (e.g., extroverted, arrogant, energetic, shy, optimistic, bad tempered, confident, patient, impatient, controlling, independent, goal oriented, self -centered, ability to make friends, etc.), computer skills, technical know-how, and so forth.

Next, the system updates the life map as needed (step 408). The life map may be updated based on information received at any time and through any number of sources. The information and data associated with each student (and school) may be encoded, limited to access by authorized personnel, and otherwise protected to comply with government, industry, and data privacy standards (i.e., HIPAA compliance, State laws, etc.).

FIG. 5 is a flowchart of a process for utilizing the life map in accordance with an illustrative embodiment. The process of FIG. 5 may begin by performing risk analysis (step 502). The system may identify risk to the students that are identified. In some embodiments, the risks may be de-identified, coded, encrypted, or otherwise abstracted so that unauthorized individuals do not become privy to that information. The system may also deidentify the data associated with students or clients so that even if viewed or retrieved it is not easy to determine the individuals associated with the data. Various user identifiers (e.g., student numbers, nicknames, etc.), encryption techniques, data hiding, or so forth may be utilized to ensure the privacy of the students.

Next, the system performs behavior, trigger, and general analysis (step 504). The various types of analysis may include medical analysis, benefit analysis, risk analysis, personality and character trait analysis, influencer analysis, partner and mentor analysis, data cross referencing, gap analysis, mentor analysis, academic analysis, timeline analysis, and other types of analysis. The illustrative embodiments may allow important data to be automatically shared with authorized and approved organizations, entities, individuals, medical professionals, government groups, and so forth. In particular, the various analysis may be utilized to determine how the student is being positively or negatively affected. The analysis may determine what conditions, stimuli, events, parameters, or variables affect the student’s various actions. For example, what conditions may cause/trigger the student’s quiz scores to drop (e.g., removal of classroom rewards, detention, too many friends in class, etc.). In another example, the system may note when the user’s attitude has improved substantially and why, if known (e.g., more free time, sports, group motivations, etc.).

Next, the system performs data management and report generation (step 506). Any number of reports may be generated automatically or based on applicable information. The system may utilize any number of queries to provide information. External devices may communicate with the system directly or through one or more networks to retrieve the reports, data, and other applicable information tracked by the system. In addition, the data may be modified, revised, or updated at any time based on real-time changes to the student, environment, or so forth.

In one embodiment, the systems, platforms, and methods herein described may utilize blockchain for data management. The data and information associated with student life maps may be de-identified from the student, school, and other identifying information to share with partner groups, such as schools, mentorships, outreach providers, government entities, and so forth. The data and information may be shared to ensure that successful results or newly obtained information may be utilized for the benefit of all. The data of the system may be stored in a standard blockchain ledger. In one example, students/guardian/families that agree to have their life map data shared in a decentralized digital ledger may have their regimens customized based on the success or failures of students that are in similar positions (as determined by de -identified data in the life maps).

The unique profile and other identifiers may be used to record life map data in a virtual, incorruptible, cryptographic database that is maintained across a network of computers accessible to other licensed users running the appropriate software (e.g.. mobile application, web browser, etc.). Each time a new life map is logged it becomes part of the ledger system and can be accessed to assist and enhance the decision-making process of new life maps, automated suggestions, interventions, resource allocation, and so forth. The system and platform may share the identified life map information between providers (e.g., schools, organizations, entities, authorized individuals, etc.). As noted, the data is stored in a secure format the identified from the student to share and access applicable information.

The blockchain processes herein described rely on networks of computing resources (see for example FIGS. 1 and 2) to share, verify, process, the information and data. New life maps, participating entities/groups, and connections may be added at any time to better inform the decision-making processes. The illustrative embodiments provide networked technical and software and infrastructure to create, share, and co-develop mentorship and outreach systems, programs, and methods for various types of service providers. The blockchain based identifiers may be linked to life maps as well as data and information from other sources, including, but not limited to, behavioral health, academic enrollment, at risk youth programs, wearable devices, and so forth. The platform incentivizes the various participants to utilize data ledgers for access, sharing, and analysis. For example, participants may be required to share anonymous data in order to access other applicable data and analysis. In another embodiment, the illustrative embodiments may utilize blockchain based tokens, or coins as a reward for building, sharing, storing, and expanding the network platform. Other traditional forms of monetization, payments, and licensing may also be utilized.

In one embodiment, administrators and other users may provide and share access to aggregated, anonymized student life maps and profiles that may be used for and continual life map creation, tracking, documenting, updating, and sharing. The illustrative embodiments may utilize blockchain to maintain full control of the data for the betterment of various entities.

The system may be utilized to store unique blockchain ledgers containing the identified and encrypted data records (step 509). For example, the data may relate to the student life map, profile, or individual data fields.

Next, the system tracks the blockchain ledger across a blockchain network (step 510). The blockchain network may be utilized to secure share the data of numerous blockchain ledgers across the blockchain network.

Next, the system tracks successes and failures associated with the data records in the blockchain ledgers (step 512). As noted, the blockchain ledgers include deidentified, life map, and other applicable data. The data is utilized to track the successes and failures of individual students, schools, and other groups for application by any number of groups.

Next, the system shares the data anonymously (step 514). As noted, the de-identified data may be de-siloed and then encrypted or decrypted as required to be anonymously shared. The data is further protected by the utilization of diagnostic codes for the different data and data fields that may require licensed software, encryption keys, passwords, or other applicable information to perform decryption.

The illustrative embodiments allow data to be captured in a secure and consistent way for utilization by any number of entities and individuals as outlined herein. The data may be received alphanumerically, through voice input, graphically, or so forth. In one embodiment, a wizard application or function may walk the user through the different questions, data fields, and other applicable information. In addition to the traditional data fields the system may be utilized to track custom information, such as fields from a mentor or school (e.g., skill/behavior, actions taken, documentation, pictures, risks, etc.).

The system may send an alert as needed indicating that there is missing data, insufficient data, suspect data, or other issues with the data received. As disclosed, the data may be submitted through a website, application, or any number of devices. The system may utilize any number of graphical (e.g., charts, graphs, visuals, etc.), spreadsheets, documents, reports, or other information to communicate applicable information with or without identifying data applicable to the students, school, mentor, and so forth. The system may incorporate biometric devices for tracking information regarding the students, mentors, and school faculty, staff, administrators, and facilities. For example, sensors (e.g., microphones, temperature sensors, accelerometers, beacons, global positioning systems, cameras/optics, etc.) in the school may sense information, such as language, speech volume, student temperature, student action/activities, and so forth. The sensors may be wearable, integrated in furniture, or environmental. The wearable sensor may be a bracelet, necklace, armband, glasses, anklet, electronic sticker, smartwatch, headband, ornament, or other item that may be worn or integrated with the clothing or body of the student. Sensors of the student’s smartphone and other personal electronics may also be utilized. The system may communicate utilizing cell signals, Wi-Fi, Bluetooth, ZigBee, global positioning system (GPS) signals, near field communications, or other existing or developing communications protocols.

The sensors may also determine a heart rate, skin response, temperature, breathing rate, blood sugar level, agitation level (e.g. voice intensity, pitch, or frequency), or other vital information associated with the student. The sensors may also be able to determine a distance between the student and one or more other students/mentors. For example, the sensors may indicate that the student is speaking to two other students that all have elevated heart rates and are yelling at each other. The sensors may be integrated with light fixtures, outlets, intercoms, tiles, or other components typically included in a room or facility. The various sensors, wearable biometric devices, and other devices in communication with the system may log activities of the students to determine activities, actions, and interactions that are positive, negative, or neutral for the student.

In one embodiment, biometrics may include pulse rate, facial expressions, sweat analysis, retinal or pupil dilation, body heat output, galvanic skin response, respiration rate, voice stress analysis, or other indicators . In one embodiment, the patients may wear medical devices, such as bracelets, glasses, smartwatches, wireless earpieces, or headbands. The medical devices may be configured to determine any of the aforementioned biometrics. The biometrics may also be associated with known emotional responses or conditions, such as anger, fear, excitement, agitation, or so forth that may be utilized to intervene or take action. In one embodiment, the biometrics may be configured to generate alerts, such as an indication that a group is becoming agitated or an event may be about to occur, such as a fight or escalated argument.

In one embodiment, cameras or optical sensors may be utilized to capture pictures, video, or so forth relating to the students for analysis by the administrator, mentors, or others when the student feels he or she is alone and not being monitored. Various output devices within the system (e.g., speakers, displays, interfaces, etc. ) may be configured to communicate auditory, video, visual, alphanumeric, tactile or other communications, alerts, or messages to the administrators, mentors, students, or other users of the system.

The illustrative embodiments also provide for a number of notifications and alerts. For example, real-time communications may be configured based on preset conditions and parameters (e.g., errors in user application, incomplete data collection or analysis, quality assurance audits, etc.). Mentor, stakeholder, team, or transdisciplinary communications are facilitated. For example, mentors may see what others have done on a student/case/issue and automatic alerts are sent out to notify needed parties to collaborate and form solutions . As a result, individual responsibility and ownership of issues are encouraged while increasing shared ownership and accountability. All data stored by the illustrative embodiments may be stored and analyzed through a set of standardized reports or customized reports based on user needs. Analysis of data may be utilized for individual student monitoring and may also look for trends in all levels of the hierarchy within the user and among a hierarchy of different users with similar purposes or roles. As a result, the system allows for process modifications at all levels that are associated with the most positive outcomes. For example, the system may create system solution suggestions based on analysis of collected data and trends for students with similarities in profile. As a result,

A browser, graphical user interface, mobile application, desktop program, as herein described may be utilized to enter, edit, manage, and access a student life map. The user interface may prompt one or more users for logging in, creating a password, modifying a password, resetting a password, system administration for providers, searching, suggested searching, alert notification generation and display, customizing a workspace, portal, or dashboard, creating new mentors, adding, modifying, and deleting entities, mentors, partners, providers, teams, service providers, and students, student data, life maps, profiles, and details, managing permissions, archiving users, creating and managing contacts, updating information, commenting, establishing settings, tracking user activity, updating service information and plans, establishing, recording, tracking, and managing risks, goals, and objectives, establishing data collection methods and profiles, performing task analysis, remote monitoring, alerts (e.g., text, audio, video, etc.), updating goals, goal activity, data collection, and so forth.

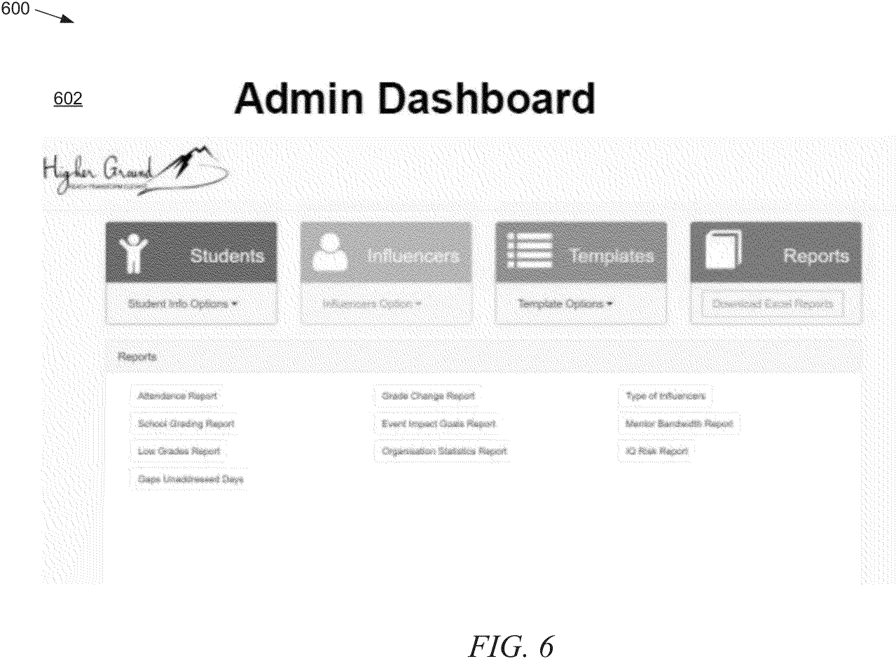

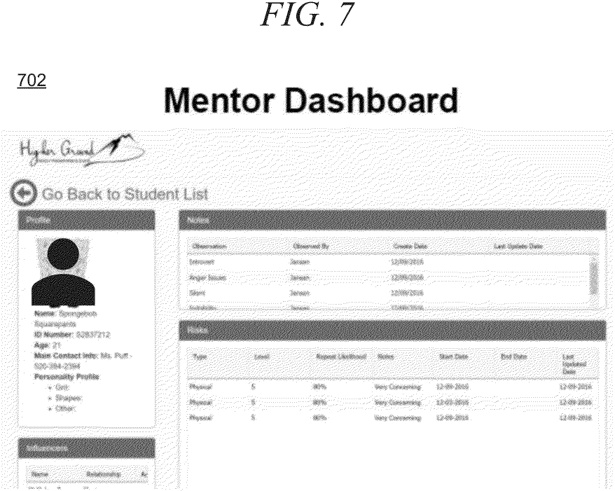

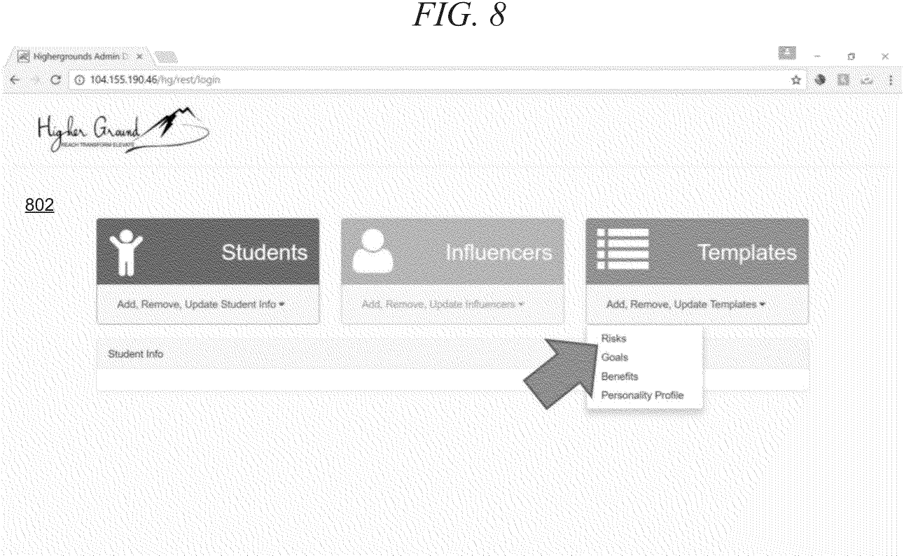

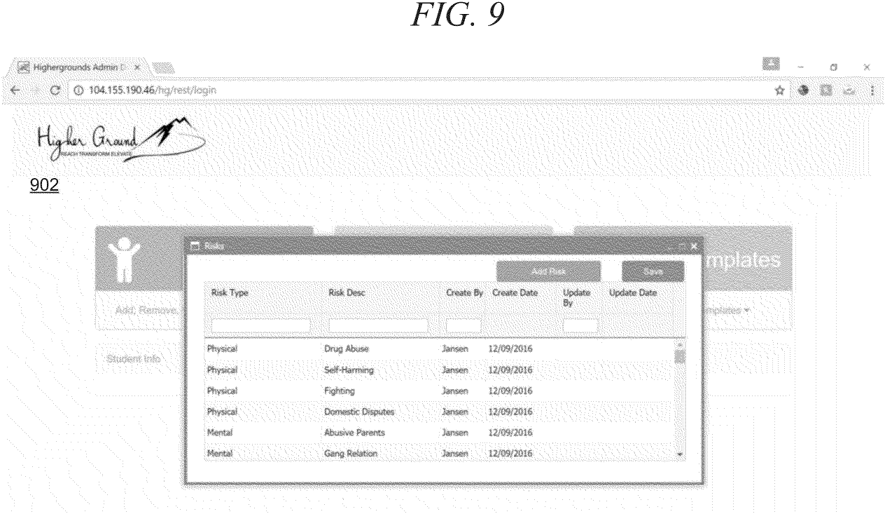

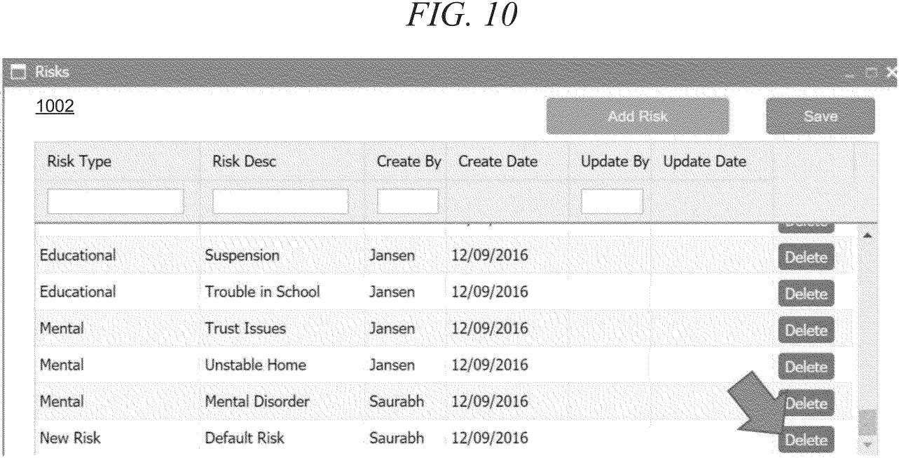

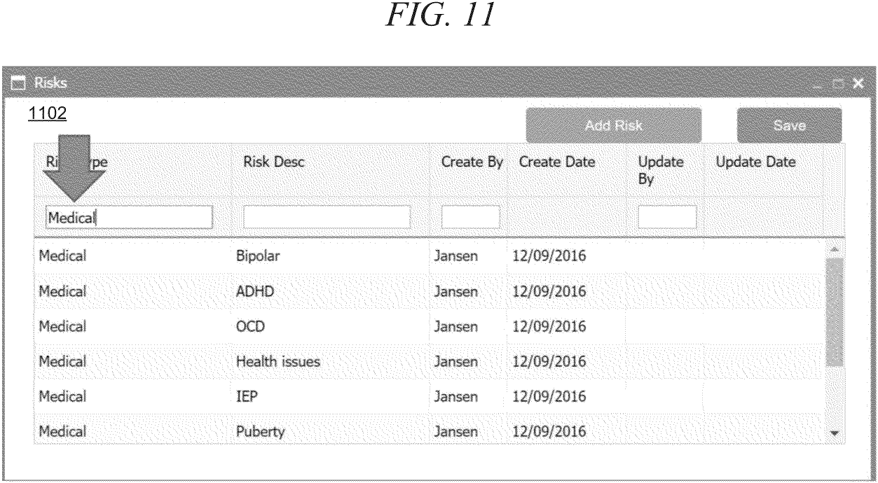

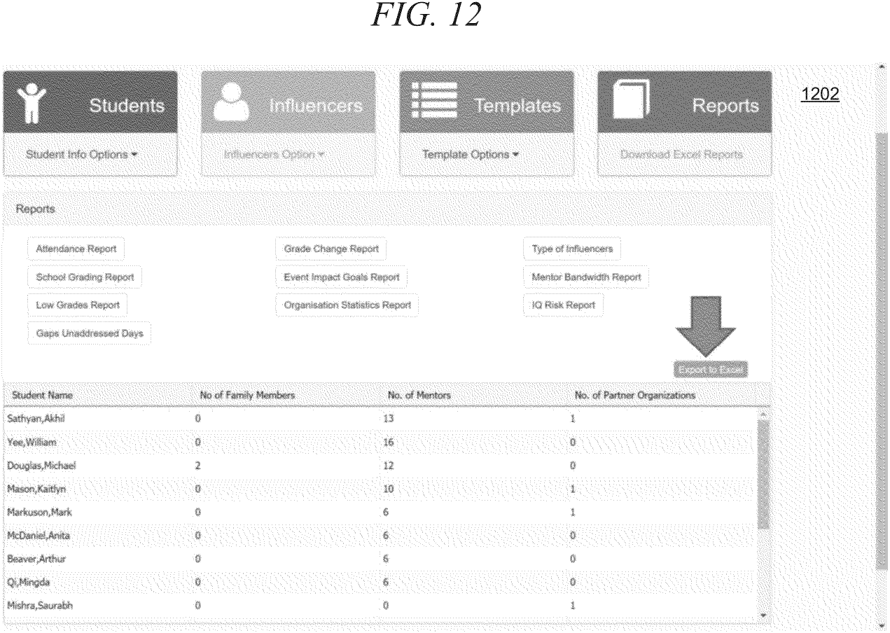

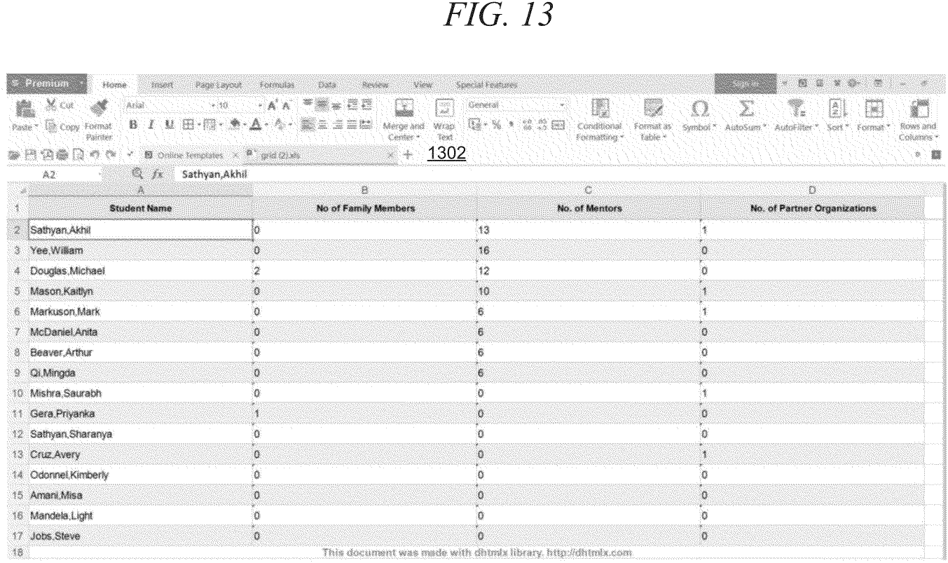

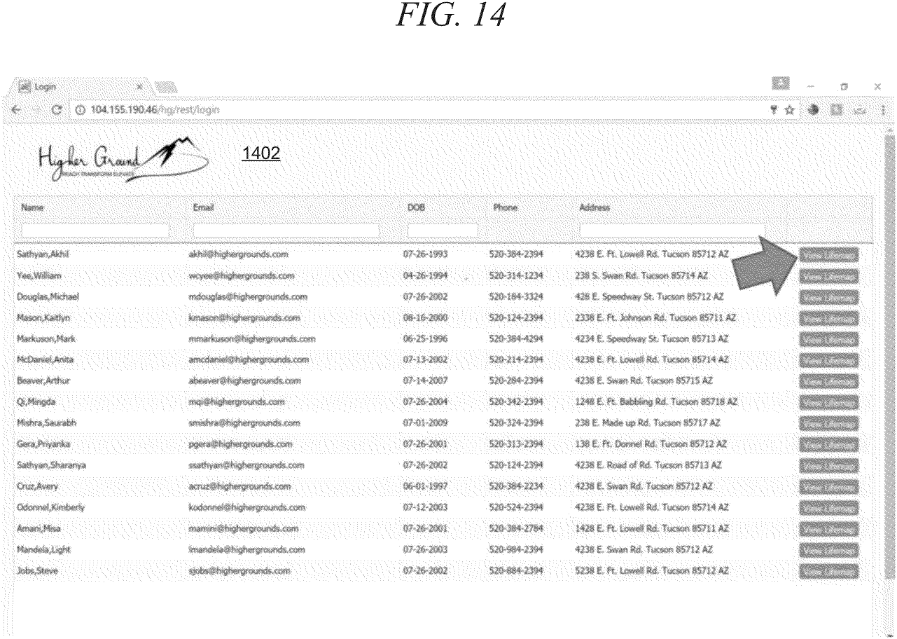

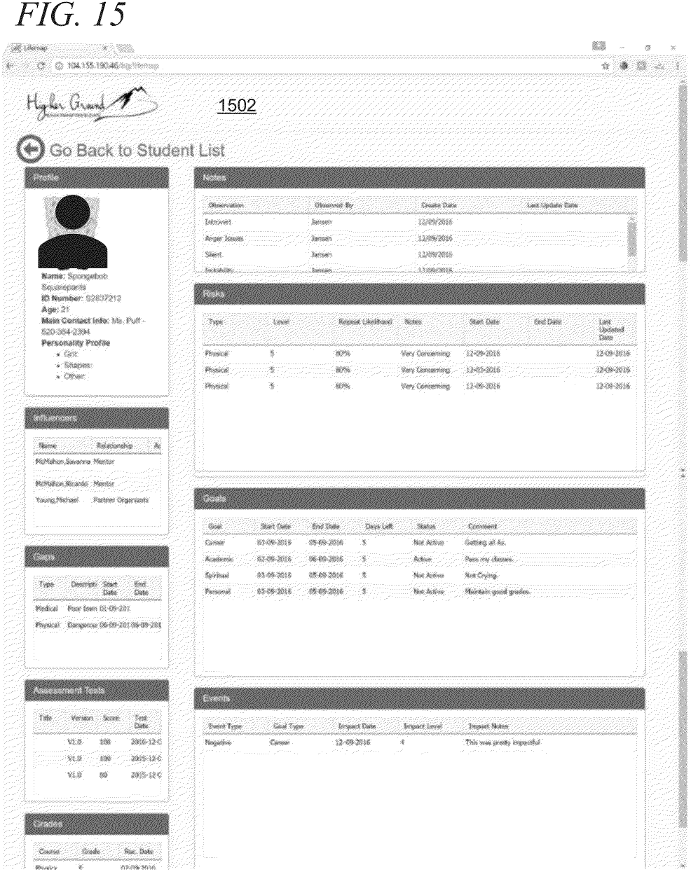

Referring now to FIGS. 6 - 16 are pictorial representations of user interfaces 600 for displaying and receiving information in accordance with illustrative embodiments. The illustrative embodiments may be implemented as part of a graphical user interface that is displayed to a device based on execution of a stand-alone or web-based application or browser. The user interfaces 600 of FIGS. 6-16 may implement any number of selection and display components, such as icons, text, hyperlinks, banners, menus, lists, tables, charts, avatars, pictures, and so forth. The user interfaces 600 may be viewed from any number of electronic devices including a screen, projection, or communication medium. The user interfaces 600 may be updated utilizing keyboards, mouse, touchscreens, audio input, tactile input, braille interfaces, and other input/output devices.

In one embodiment, the application may be hosted as a cloud-based application for utilization by any number of devices and parties. FIG. 6 shows an administrative dashboard 602. The administrator may be required to provide a username and password to login to the system. The administrative dashboard allows a school/organization to create, read, update, and delete data regarding the regarding students, influencers, templates (e.g., types of risks, goals, etc.), and reports. The operations may be applicable to tables of data within the user interfaces 600, including, but not limited to, goals, personality profile, benefits, and mentors (e.g., potential subclass of influencers).

FIG. 8 illustrates a user interface 802 for creating, reading, updating, and deleting information, data, and functionality. For example, by selecting “Add, Remove, Update” a user may be presented with an option for editing information, such as risks, goals, benefits, and personality profile. As shown in the user interface 902 of FIG. 9. a pop up may be displayed with the applicable information or records. For example, a table may be utilized to display the records of applicable “risks” or add/save new risks. New risks may be added and saved as needed utilizing the user interface 902. The risk information may include risk type, risk description, created by, creation date, updated by, update date, and so forth. The fields or attributes displayed by the user interfaces 600 may be updated as needed.

Information may be updated, added, or deleted utilizing a double click, drop down menu, or other user selections. As shown in the user interface 1002 of FIG. 10, deletion of records may be performed as needed for risks and the other applicable data available through the user interfaces 600. The user interfaces 600 may also allow filtering of records. The user interface 1102 of FIG. 11 shows how risk may be filtered by risk type (e.g., medical) by typing the text in a search/filter field. The other fields, data, and records saved by the application may also be searched, queried, filtered, ordered (e.g., date, action, priority, significance, etc.), or otherwise processed.

The user interfaces 600 may also be utilized to generate different reports. For example, the user interface 1202 of FIG. 12 illustrates report generation. Reports may utilize SQL queries to generate the report. The reports may be viewed locally or exported to one or more document formats (e.g.. Excel, Word, pdf, etc.), such as document 1302 of FIG. 13. Examples of common reports may include an attendance report, school grading report, low grades report, gaps, unaddressed days, grade change report, event impact goals report, organization statistics report, type of influencers, mentor bandwidth report, and IQ risk report. For example, the type of influencers report may show the student name, number of family members, number of mentors, and number of partner organizations (if any). Any number of reports may be generated as are herein described. Custom reports may display selected information, data, records, and so forth.

Turning back to FIG. 7. a mentor dashboard is shown. The mentor dashboard 702 may allow mentors to view information about their students. Upon login, the user may be able to view the name, email, date of birth, phone number, and address of individual students associated with the mentor or school (e.g., see user interface 1402 of FIG. 14). The mentor may select to see information, such as the life map. If the life map is selected a window, screen, or interface, such as the user interface 1502 of FIG. 15 may be shown.

The administrators may have the capacity to add, edit, archive, and delete mentors and students. The various user interfaces may also provide user access for monitoring a patient’s behavioral status. The schools may represent supervisors or may also be mentors associated with one or more students. Information and data management performed by the user interfaces of the system/server is further described below.

The system or server stores and provides access to every interaction with the student life map and file (e.g., updates, general notes, recorded data, event-triggered notifications, etc.) included in the data or specific to the student. As a result, the schools may log all activities within a file thereby allowing other schools to view the activities based on the pre-established settings and permissions. For example, schools, non-profits, businesses, hospitals, or other organizations may have sharing agreements for exchanging data while still complying with the applicable laws and industry practices.

Administrators may manage their team of schools who work directly with students to administer information and data, such as risks, goals, and objectives. The administrators may have complete access to the schools and the students to assign the students to individual schools through the user interface. In one embodiment, the schools represent authorized users able to access all or portions of the server applicable to the service provider, view elements of the life plans, view and add risks, goals, and objectives for students that are associated with the schools to enter data, information, statistics, and record audio and video permitted by the administrators.

The mentors may utilize the user interface of web browsers (e.g., Chrome, Internet Explorer, FireFox, Safari, Opera, etc.) applications (e.g.. Android, iOS, Windows, etc.) to view the data. For example, mobile applications executed by electronic devices may communicate the data that is saved to the server. The user interface may provide an easy to navigate and user -friendly interface with quick search utilities and filters (e.g., location, student assignments, etc.). The mentors may represent volunteers, teachers, support staff, parents, professionals, and in some cases the students themselves may be given full or limited access to their own data. In one embodiment, the mentors may represent the full hierarchy of individuals associated with students from administrators to support staff. From each client-dashboard available through the user interface, the schools may have access to a log of interactions associated with the data (e.g., data collection, inactivity alerts, etc.).

The communications with the system and server of the illustrative embodiments are secured for sensitive electronic protected health information and to comply with applicable laws, such as HIPAA. Communications with the server, whether in real-time or file transfers, may be encrypted or utilize other secure data transmission protocols (e.g., SSL, https, security certificates, etc.). The server may also be configured to communicate with any number of databases or systems, internal or external, maintained or accessible by the administrator, such as electronic client records databases. The applications may record information and data even if one of the networks is not currently available or if a utilized wireless device and the system are offline. Synchronization methods and modes may be utilized as necessary (e.g., cloud synchronization). In one embodiment, conflicts and synchronization of information may be presented to the administrators or mentors. In one embodiment, variance conflicts may be resolved by an automated process or based on input from the administrator.

In one embodiment, users accessing the server through the user interface may be able to view students by location, caseload, or assignment. For example, the students may be associated with one or more locations, mentors, schools, services, or programs. The locations may allow for further sub categorization, such as national, regional, or local programs. In one embodiment, administrators may be able to see students associated with their respective schools or treatment team. In one example, the schools may be presented with a default list of students that have most recently been reviewed at login with options to search by location, student name, or other identifying information.

In one embodiment, the alerts and notifications may be configured to communicate information. For example, any number of alerts and notifications may be communicated through the interface. The interface may be configured to communicate with wired and wireless networks. As a result, the alerts and notifications may represent emails, text messages, in -application messages or alerts, audio, video, picture, or text messages, streaming communication sessions, or other similar alerts, messages, or communications that are sent in real-time or near real-time. The alerts and notifications may also include hyperlinks back to the original source of the alert or notification for easy review and to address further action that may be needed. The alerts and notifications may also utilize a feed to send information to users. The feed may be similar to a newsfeed and may be organized by subject date in which users may create dialogues of streams of information related to a particular topic for a student. Individual users may add to each other’s feeds or may create new ones. The user may also be able to view and re-enter the most recently accessed areas of an application utilizing a history or most recently utilized function.

In one embodiment, the various reports may be utilized to communicate charts and graphs, track and record progress, determine timeliness of data entry, and other information. The reports may be based on students, mentors, schools, region, or date ranges. The reports are configured to be customizable to track and display a variety of process mechanisms input or entered by a user or administrator based on the specific needs for which the illustrative embodiments are utilized. The reports may include quick snapshot reports as well as long-term and comprehensive reports.

The system may be configured to present information graphically utilizing bar charts, pie charts, scatter plots, line graphs, and other similar display messages. Graphical representations may include information embedded in multiple layers for automatically displaying additional information to a user (e.g., displaying identifying information and statistics when hovering over a data point). Reports may also display information statistically, utilizing percentages, in standard document formats (e.g., Word. Excel, GoogleDocs, etc.).

In one embodiment, the user may set a date range for information to be displayed and specific risks/goals/objectives active during the date range may be automatically entered or selected by the user for display. A current status may indicate the status for a student or subject for all ongoing activities. A final status report may graphically display goals the final outcome of goals and associated activities that were closed during a specified data range. The various reporting abilities of the illustrative embodiments are configured to apply to privacy laws, such as HIPAA, and may require waivers or authorizations to share information even within an organization for assistance, teaching, mentoring, or treatment purposes. For example, partners, contractors, or other parties may perform reporting as needed or required.

The various reports may be generated based on an identified group of students automatically or manually selected by a user. For example, the report for the group may show the student, risks, goal/objectives, current status, and current status date. The reporting may allow a user to drill down from the school level to the student and associated risks and goal level.

In one embodiment, each of the various potential data collection method may include a specific set of rules related to the data entry and visual presentation of information, data, graphs, and reports available through the system. In addition to this information, graphics, such as graphs (e.g., risks, goals, etc.), may demonstrate student data results across different data fields. The setup and configuration of the information and graphics may be managed by the administrator. The display of the information and graphics may also take into consideration specific device orientation, display options (e.g., graph layout and corresponding information may be presented in a first configuration when viewed in a landscape mode and in a second configuration when viewed in a portrait mode), display limitations, permissions, and so forth. In one embodiment, each graphic is the result of specific formulas and calculations. Each user may submit the features, parameters, criteria, or calculations utilized to generate graphics, such as performance measurement charts. In one embodiment, the graphs may be produced in real-time as data are entered or may be set to display historical data.

In one embodiment, the system may utilize a setup and/or management wizard to perform account setup, request information, and so forth. The users of the system may also be presented with options for entering other data criteria, value or number specifications, and customizations. In one embodiment, the status of each student may be automatically determined and displayed. The status may include any number of rules, criteria, parameters, or thresholds for calculation and displaying information and data. The status may also be color-coordinated. For example, progress may be noted in green, lack of progress may be noted in orange, a significant lack of progress may be noted in red, and mastery or maintained mastery may be noted in purple. Regression from mastery may also be noted by color.

In one embodiment, data points of significance may be utilized to generate an alert. For example, identified users may receive a notification within the system or an email, text message, in-app message, or other alert. In one embodiment the email may include the mentor, student’s name, risk, goal, reason for notification, date, and any other applicable information.

The illustrative embodiments may be applied to any number of performance management methodologies, such as prisoner management, traditional school counseling, medical and behavioral treatments, addiction treatments, life coaching, and so forth. In one embodiment, the illustrative embodiments may compile life maps, information, and data from any number of students, mentors, and administrators to provide decision-support based on the compiled data. For example, based on research and development, new practices, teaching techniques, actions, medications, or mentoring/medication plans may be suggested based on the individual or aggregated recorded data. As a result, services may be adapted in real-time based on dynamic learning from aggregated and shared data. Reporting may be performed without compromising the privacy of client information and data or violating applicable laws. For example, the identifying information, such as client name or location, may be removed from the aggregated data when compiled to provide for anonymity. In addition, the removal of identifying information may ensure that inherent biases, assumptions, inferences, or statements are not promulgated. As a result, more and more students may utilize the systems and methods herein described increasing the amount of data and accuracy even more.

In one embodiment, the compiled data may be mined utilizing relational database management systems. The data may also be searched utilizing key word searches. Boolean searches, wild card searches or other similar search protocols, strategies, and algorithms. The generic compiled information may also be sold by a system administrator (or alternatively to service providers or other designated parties) to organizations, schools, universities, drug manufacturers, governments, or other parties to encourage development of new teaching techniques, mentoring plans, and student-based efforts.

As will be appreciated by one skilled in the art, aspects of the present inventive subject matter may be embodied as a system, method or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non -exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium (i.e., non-transitory) that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc.. or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Turning again to FIG. 1, FIG. 1 depicts an example of a server 106. The server 106 and other computer systems of FIG. 1 may include a processor unit (possibly including multiple processors, multiple cores, multiple nodes, and/or implementing multi-threading, etc.) and other components that are not shown. The server 106 includes a memory. The memory may be system memory (e.g., one or more of cache, SRAM. DRAM, zero capacitor RAM, Twin Transistor RAM, eDRAM, EDO RAM, DDR RAM, EEPROM, NRAM. RRAM, SONOS, PRAM, etc.) or any one or more of the above already described possible realizations of machine -readable media The computer system also includes a bus (e.g., PCI, ISA, PCI-Express, HyperTransport®, InfiniBand®, NuBus, etc.), a network interface (e.g., an ATM interface, an Ethernet interface, a Frame Relay interface, SONET interface, wireless interface, etc.), and a storage device(s) or database (e.g.. optical storage, magnetic storage, etc.). In one embodiment, the system memory or database 108 associated with the server embodies functionality to implement embodiments described above.

In addition, any one of these functionalities may be partially (or entirely) implemented in hardware and/or on the processing unit of the server 106. For example, the functionality may be implemented with an application specific integrated circuit, in logic implemented in the processing unit, in a co-processor on a peripheral device or card, etc. Further, realizations may include fewer or additional components not illustrated in FIG. 1 (e.g., video cards, audio cards, additional network interfaces, peripheral devices, etc.)

While the embodiments are described with reference to various implementations and exploitations, it will be understood that these embodiments are illustrative and that the scope of the inventive subject matter is not limited to them. In general, techniques for managing goals and outcomes for organizations, groups or individuals as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A system, coniprising:
one or more processors; and
memory communicably connected to the one or more processors, and comprising instructions that when executed, cause the one or more processors to:
communicate with one or more communication devices to present nested questions to one or more users soliciting information relevant to a first student;
receive answers to the nested questions via the one or more communication devices,
generate a life map for the first student based on the answers;
update the life map based on tests, assessments, and observations of the first student;
analyze the life map to determine conditions, stimuli, events, and variables that affect the first student’s behavior; and
generate one or more reports based on the analysis of the life map.

2. The system of claim 1, wherein the one or more reports comprise an influencer report that identifies influencers associated with the first student based on influencer types, the influencer types including family members, friends, mentors, and partner organizations.

3. The system of claim 1, wherein the one or more reports comprise a potential gaps report identifying potential gaps that have been unaddressed for the first student, the potential gaps report including gap type, gap description, and number of unaddressed days.

4. The system of claim 1, wherein the one or more reports comprise an event goal report identifying event types that impact goals for the first student, the event goal report including event type, goals impacted, and average impact level.

5. The system of claim 1, wherein the one or more reports comprise an emotional intelligence report specifying a social-emotional learning quotient for the first student.

6. The system of claim 1, wherein the one or more reports comprise an organization statistics report specifying a total number of students that each partner organization is associated with.

7. The system of claim 1, wherein the instructions further cause the one or more processors to:
remove identifying information from the one or more reports; and
share the one or more reports with one or more organizations.

8. The system of claim 1, wherein to update the life map, the instructions further cause the one or more processors to:
identify at least one data field requiring supplemental information in the generated life map; and
performing a test to obtain the supplemental information required by the at least one data field.

9. The system of claim 1, wherein to update the life map, the instructions further cause the one or more processors to:
identify at least one data field requiring supplemental information in the generated life map; and
performing an assessment to obtain the supplemental information required by the at least one data field.

10. The system of claim 1, wherein to update the life map, the instructions further cause the one or more processors to:
identify at least one data field requiring supplemental information in the generated life map; and
performing an observation to obtain the supplemental information required by the at least one data field.

11. The system of claim 1, wherein the instructions further cause the one or more processors to:
analyze personality character traits of the first student in the life map to determine behavior factors that influence a development of a socio-emotional skill; and
generate a recommendation or a pairing of at least one program, organization, service, or mentor for the first student according to the analysis of at least the personality and character traits of the first student,
wherein the personality and character traits comprise personality indicators, character traits, and strength factors of the first student.

12. The system of claim 1, wherein the information includes at least activities, risk behaviors, influencers, personality and character traits, and goals associated with the first student.

13. A method comprising:
communicating, by one or more processors, with one or more communication devices to present nested questions to one or more users soliciting information relevant to a first student;
receiving, by the one or more processors, answers to the nested questions via the one or more communication devices;
generating, by the one or more processors, a life map comprising a plurality of data fields tracking at least risk behaviors, influencers, personality and character traits, and goals associated with the first student based on the answers;
identifying, by the one or more processors, at least one data field requiring supplemental information in the generated life map;
updating, by the one or more processors, the life map based on tests, assessments, and observations of the first student to obtain the supplemental information;
analyzing, by the one or more processors, the life map to determine conditions, stimuli, events, and variables that affect the first student’s behavior; and
generating, by the one or more processors, one or more reports based on the analysis of the life map.

14. The method of claim 13, wherein the one or more reports comprise an influencer report that identifies influencers associated with the first student based on influencer types, the influencer types including family members, friends, mentors, and partner organizations.

15. The method of claim 13, wherein the one or more reports comprise a potential gaps report identifying potential gaps that have been unaddressed for the first student, the potential gaps report including gap type, gap description, and number of unaddressed days.

16. The method of claim 13, wherein the one or more reports comprise an event goal report identifying event types that impact goals for the first student, the event goal report including event type, goals impacted, and average impact level.

17. The method of claim 13, wherein the one or more reports comprise an emotional intelligence report specifying a social-emotional learning quotient for the first student.

18. The method of claim 13, wherein the one or more reports comprise an organization statistics report specifying a total number of students that each partner organization is associated with.

19. The method of claim 13, further comprising:
removing, by the one or more processor, identifying information from the one or more reports; and
sharing, by the one or more processors, the one or more reports with one or more organizations.
